(19) United States
(12) Patent Application Publication
(10) Pub. No.: US 2017/0113270 A1
(43) Pub. Date: Apr. 27, 2017

(54) MELTING UNIT FOR MELTING DOWN CASTING MATERIALS AND METHOD FOR PRODUCING MOLTEN MATERIAL FOR CASTINGS

(71) Applicant: Stephan Schwenkel, Heiligenhaus (DE)

(72) Inventor: Stephan Schwenkel, Heiligenhaus (DE)

(21) Appl. No.: 15/318,164

(22) PCT Filed: Jul. 6, 2015
(86) PCT No.: PCT/EP2015/065391

§ 371 Date: Dec. 12, 2016

(30) Foreign Application Priority Data
Jul. 21, 2014 (DE) 10 2014 110 251.7

(51) Int. Cl. B22D 41/01; B22D 41/16; F27B 14/06; F27D 3/14; F27B 9/02; B22D 41/08; F27D 11/06

(52) U.S. Cl. CPC B22D 41/01; B22D 41/08; B22D 41/16; F27D 11/06; F27D 3/14; F27B 9/02; F27B 14/061; F27B 2014/004

(57) ABSTRACT

A melting unit for melting down casting materials and a method for producing molten material for casting.

The invention relates to a melting apparatus for melting casting materials and also a process for producing a melt for casting.

In casting, a solid body composed of a casting material is formed from the melt of the casting material after solidification of the latter in a casting mold.

Casting materials based on, in particular, ferrous metals and nonferrous metals are known. Widespread casting materials are cast iron, viz, an iron-carbon compound, and cast steel.

The casting of casting materials is carried out in foundries. In foundries, a melt in the form of the desired casting material is firstly produced from various raw materials by melting in melting furnaces, for example in cupola furnaces. This melt can subsequently either be cast directly or be transferred into a casting furnace which is located downstream in the process and serves for storing and/or treating the melt and/or keeping the melt hot until it is fed into the downstream casting molds in which a solid body or a casting is formed from the melt, Casting processes using a casting furnace have been found to be particularly useful since they represent a buffer between production of the melt of the casting material from the raw materials and the casting of the melt.

Although correspondingly configured casting processes using casting furnaces have in principle been found to be useful in practice, these also have numerous disadvantages.

Thus, for example, they can lead to throughput problems in the process when too little melt is made available to the casting furnace by the melting furnace. Furthermore, there can, for example, be quality problems in respect of the melt when the feed line for melt from the casting furnace to the casting molds becomes blocked, since in this case a change in the chemical composition of the melt remaining for a prolonged period in the casting furnace can occur as a result of burning.

Furthermore, the transport of the melt from the melting furnace to the casting furnace can be problematical. This is because the melt is for this purpose generally transported in suitable vessels, for example by means of a fork lift, which can be associated. with a risk of injury to persons in the case of an accident.

Furthermore, the melting furnace and casting furnace have to have a large capacity so that there is a sufficient buffer of melt of the casting material. At a typical throughput of, for example, about 10 t of casting material per hour, melting furnaces have, for example, a capacity of about 10 t for the casting material or the parent raw materials and casting furnaces have, for example, a capacity of from 3 t to 10 t of molten casting material, for example a cast iron melt.

According to the invention, it has been recognized that the above-described problems which result from the known technology for casting casting materials arise, in particular, from the coupling of melting furnace and casting furnace with one another. The basic inventive concept is therefore to provide a technology by means of which decoupling of melting furnace and casting furnace is possible.

In the light of this background, it is an object of the invention to provide a melting apparatus for melting casting materials and also a process for producing a melt for casting, by means of which casting of casting materials is possible without the above-described problems occurring. In particular, the invention should provide a technology by means of which complete decoupling of melting furnace and casting furnace is possible.

The invention provides a melting apparatus for melting casting materials, having the following features:
a first furnace vessel and a second furnace vessel;
the first furnace vessel is configured for melting casting materials and for accommodating the melt formed by melting;
the second furnace vessel is located downstream in process engineering terms of the first furnace vessel in such a way that melt formed from casting materials in the first furnace vessel can be conducted into the second furnace vessel;
the second furnace vessel is configured for accommodating the melt which can be conducted from the first furnace vessel into the second furnace vessel and for increasing the temperature of the accommodated melt to the casting temperature for this melt.

For the purposes of the invention, the term melting refers to the production of a melt from a solid material, in particular a solid casting material.

A casting material can, according to the invention, be any casting material for casting, in particular a casting material in the form of cast iron or cast steel.

The casting temperature is the temperature of the melt of the casting material which the latter should ideally have in the furnace apparatus for the subsequent casting into casting molds. In general, this casting temperature is superheated to a few degrees Celsius above the optimum temperature during subsequent casting, so that the casting temperature is also referred to as superheating temperature.

Due to the second furnace vessel being located downstream of the first furnace vessel in the process, melt produced in the first furnace vessel subsequently goes into or is conducted into the second furnace vessel during normal operation of the melting apparatus of the invention.

According to the invention, it has been found that the melting apparatus of the invention allows complete decoupling of the production of a melt of the casting material from the raw materials from the provision of such a melt for casting into casting molds. This is because the melting apparatus of the invention allows both melting of a solid casting material and the treatment of the melt in such a way that, in particular, it is available for casting, in particular has the intended casting temperature. For this purpose, the melting apparatus of the invention has a first furnace vessel in which a melt of the casting material can firstly be produced from the solid casting material. To treat this melt in such a way that it is present in a form desired for casting, in particular has the desired casting temperature, the melting apparatus of the invention has the second furnace vessel. A special feature of the melting apparatus of the invention is, in particular, that the second furnace vessel is not only configured for keeping the melt taken up from the first furnace vessel hot but for increasing the temperature of the melt taken up from the first furnace vessel. Furthermore, the first and second furnace vessels are preferably configured with a relatively small volume for accommodating casting material or a melt formed therefrom, since it has been recognized according to the invention that this brings numerous advantages. Thus, only a relatively small amount of melt is kept ready in liquid form in the furnace apparatus in the case of a comparatively small volume of the second furnace vessel and, at the typical throughputs, is consumed more quickly than in the case of apparatuses according to the prior art. This results in a short residence time of the melt in the furnace apparatus of the invention, in particular in the second furnace vessel. This, however, minimizes the risk of a deterioration in quality of the melt during residence in the furnace apparatus of the invention, since, in particular, the risk of burning is minimized as a result of the short residence time. At the same time, the possibility of a rapid change between melts of different, desired compositions results from the possible short residence time of the melt in the furnace apparatus of the invention. Furthermore, at a small volume of the first and second furnace vessels and the resulting shorter process times resulting therefrom, only a smaller quantity of energy compared to the prior art is required to melt a desired amount of casting material and make it available for casting.

The first furnace vessel has an inlet for introduction of solid casting material into the first furnace vessel. This inlet can be, for example, an opening in the first furnace vessel. The inlet can, for example, be closeable. The inlet of the first furnace vessel is preferably located in the upper region of the first furnace vessel.

To melt solid casting material introduced into the first furnace vessel, the first furnace vessel has a device for heating solid casting material present in the first furnace vessel to above its melting point. This device can in principle be any device known from the prior art for melting casting materials in a furnace vessel, for example a gas burner. However, the first furnace vessel is particularly preferably inductively heatable. For this purpose, the first furnace vessel has an induction device, in particular an induction coil, by means of which the first furnace vessel is inductively heatable or heatable by means of induction as device for melting casting material present in the first furnace vessel. Overall, the first furnace vessel can for this purpose be configured, for example, in the form of an induction furnace. The particular advantage of such an inductively heatable first furnace vessel is, in particular, that solid casting material present in the first furnace vessel can be melted particularly quickly, so that the first furnace vessel can be used very flexibly for melting casting materials of desired different compositions.

The first furnace vessel is configured overall so that the casting material present in the first furnace vessel can be heated to a temperature at which it melts or is present as melt. However, the first furnace vessel does not have to be configured so that the melt which can be formed in the first furnace vessel is heatable to the casting temperature. This can he advantageous in so for as the device for heating casting material in the first furnace vessel does not have to be dimensioned so that it necessitates heating of the melt of casting material present in the first furnace vessel to casting temperature.

It is possible, for example, for the first furnace vessel to have, based on a throughput of one metric ton of cast iron per hour, a device for heating or melting casting material present in the first furnace vessel by means of a power of not more than 450 kW, i.e., for example, not more than 400 kW, 350 kW, 300 kW or not more than 250 kW, in an far as the first furnace vessel is configured for accommodating a casting material in the form of cast iron. If the first furnace vessel is configured for accommodating a casting material in the form of cast steel, it is possible, for example, for the first furnace vessel to have, based on a throughput of one metric ton of cast iron per hour, a device for heating or melting cast steel present in the first furnace vessel by means of a power of not more than 500 kW, i.e., for example, not more than 450 kW, 400 kW, 350 kW, 300 kW or not more than 250 kW. The power of the device for heating can, in particular, change linearly with the throughput, i.e., for example, be twice as high as the above power values at a throughput of 2 metric tons per hour and half as high at a throughput of 0.5 metric tons per hour.

If the first furnace vessel is configured for accommodating a casting material in the form of cast iron, the cast iron or a melt formed therefrom is preferably heatable to a temperature in the range from 1000° C. to 1300° C., in particular, for example, to a temperature of at least 1050° C. or 1100° C. or, for example, to a temperature of not more than 1250° C. or 1200° C., in the first furnace vessel. If the first furnace vessel is configured for accommodating a casting material in the form of cast steel, the cast steel or a melt formed therefrom is preferably heatable to a temperature in the range from 1400° C. to 1600° C., in particular, for example, to a temperature of at least 1450° C. or, for example, not more than a temperature of 1550° C., in the first furnace vessel.

The first furnace vessel preferably s an outlet for discharging the melt formed in the first furnace vessel.

The first furnace vessel preferably has such an outlet at the bottom so that the first furnace vessel does not have to be tilted in order to discharge the melt from the first furnace vessel. This has the advantage that the first furnace vessel can be used continuously for melting casting materials. An outlet, in particular a bottom outlet, of the first furnace vessel can preferably be closable, for example by means of a plug or slide valve, as are known for a ladle or a tundish in steel production.

The first furnace vessel can be provided on at least part of the inside with a refractory lining, in particular in the regions in which a melt of the casting material is present. In a preferred embodiment, the first furnace vessel has regions at which it is not provided on the inside with a refractory lining, in particular in the regions in which no melt of the casting material is present during operation of the melting apparatus of the invention. A particular advantage of a first furnace vessel which has regions in which it is not provided on the inside with a refractory lining is that the furnace vessel can significantly more effectively be supplied with heat energy in these regions than in regions which are provided with a refractory lining, in particular if the first furnace vessel is inductively heatable.

The second furnace vessel has an inlet for taking up the melt of the casting material which can be conducted from the first furnace vessel into the second furnace vessel. Such an inlet can be, for example, an opening which can, for example, also be closable. The opening is preferably arranged at the top of the second furnace vessel.

To increase the temperature of the melt of the casting material taken up by the first furnace vessel to the casting temperature for this melt, the second furnace vessel has a device for heating this melt. This device can in principle be any device known from the prior art for melting of casting materials in a furnace vessel, for example a gas burner. However, the second furnace vessel is particularly preferably inductively heatable. For this purpose, the second furnace vessel has an induction device, in particular an induction coil, by means of which the second furnace vessel is inductively heatable or heatable by means of induction as device for heating melt of the casting material present in the second furnace vessel. Overall, the second furnace vessel can for this purpose be configured, for example, in the form of an induction furnace, for example in the form of a crucible furnace, with the melt being inductively heatable to the casting temperature. The particular advantage of such an inductively heatable second furnace vessel is, in particular, that melt of the casting material present in the second furnace vessel can be heated particularly quickly to the casting temperature thereof.

The second furnace vessel preferably has, as indicated above, a comparatively small capacity for the melt of the casting material. If the casting material is, for example, cast iron or cast steel, the second furnace vessel has, for example, a capacity for a melt of cast iron of not more than 20% of the throughput of the furnace apparatus according to the invention per hour, i.e., for example, not more than 15%, 10% or 5% of the throughput per hour. In particular, if the second furnace vessel is configured for accommodating a cast iron melt in the abovementioned range, the device for heating the melt present in the second furnace vessel can, based on a throughput of one metric ton of cast iron per hour, have a power of, for example, not more than 200 kW, i.e., for example, not more than 150 kW, 100 kW or not more than 50 kW. If the second furnace vessel is configured for accommodating a cast steel melt in the abovernentioned range, the device for heating the melt present in the second furnace vessel can, based on a throughput of one metric ton of cast steel per hour, have a power of, for example, not more than 250 kW, i.e., for example, not more than 200 kW, 150 kW, 100 kW or not more than 50 kW.

If the second furnace vessel is configured for increasing the temperature of a cast iron melt to casting temperature, the second furnace vessel can be configured in such a way that the cast iron melt can be heated to a temperature in the range from 1400° C. to 1600° C., i.e., for example, to a temperature of at least 1450° and, for example, to a temperature of not more than 1550° C. If the second furnace vessel is configured for increasing the temperature of a cast steel melt to casting temperature, the second furnace vessel can be configured in such a way that the cast steel melt can be heated to a temperature in the range from 1600° C. to 1700° C., i.e., for example, to a temperature of at least 1620° and, for example, to a temperature of not more than 1680° C.

The second furnace vessel has an outlet for discharging the melt formed from the second furnace vessel.

On the inside, the second furnace vessel is provided with a refractory lining which surrounds the furnace space for accommodating the melt.

The melt formed in the first furnace vessel can in principle be conducted into the second furnace vessel by means of any means known from the prior art for conducting melts. For example, the melt can be conductable via channels, tubes or combinations thereof from the first furnace vessel into the second furnace vessel. These means of conducting the melt can, for example, be made of a refractory material.

The melting apparatus is preferably configured in such a way that the melt can be conducted under the action of gravity from the first furnace vessel into the second furnace vessel.

In this case, the outlet for discharging the melt from the first furnace vessel can particularly preferably be arranged above, i.e. vertically higher than the highest bath surface of the melt in the second furnace vessel, i.e. above the inlet of the second furnace vessel, in so far as the inlet of the second furnace vessel is arranged above the highest bath surface of the melt in the second furnace vessel.

This makes it possible for the melt to flow under the action of gravity from the first furnace vessel into the second furnace vessel.

In a preferred embodiment, the first furnace vessel and the second furnace vessel are arranged relative to one another in such a way that the melt flows in free fall from the first furnace vessel into the second furnace vessel. To realize this concept according to the invention, the outlet of the first furnace vessel can, for example, be arranged above the inlet of the second furnace vessel in such a way that melt flowing out from the outlet of the first furnace vessel flows under the action of gravity through the inlet of the second furnace vessel into the latter.

In a preferred embodiment, the melting apparatus of the invention has a plurality of first furnace vessels. These can in each case be configured as described here. The advantage of a melting apparatus having a plurality of first furnace vessels is, in particular, that the latter can be charged with solid casting materials each having a different composition, so that the melts formed therefrom can be combined in the second furnace vessel to form a castable melt which represents a combination of the compositions of the melts from the first furnace vessels.

In one embodiment, the melting apparatus of the invention can have a plurality of second furnace vessels. These can each be configured as described here. The advantage of a melting apparatus having a plurality of second furnace vessels is, for example, that the latter can be charged with liquid casting materials each having a different composition from the first furnace vessels, and these liquid casting materials can, for example, be fed to different casting devices.

The second furnace vessel is preferably configured for conducting the melt which has been heated to casting temperature in the second furnace vessel into a downstream process stage, for example for conducting into at least one of the following process stages: a device for treating the melt or a casting device. For the present purposes, a treatment device is a device by means of which the melt can be treated according to the prior art For the present purposes, a casting device is a casting device having one or more casting molds.

The melting apparatus is preferably configured in such a way that the melt which has been heated to casting temperature in the second furnace vessel can be conducted without an intermediate process engineering step, i.e., in particular, without further heating of the melt, to a casting device. In a preferred embodiment, the melt which has been heated to casting temperature in the second furnace vessel can be conducted under the action of gravity into the casting device, for example via channels or tubes. As a result, possibly hazardous transport of the melt to the casting molds is not necessary.

To discharge the melt from the second furnace vessel, the second furnace vessel preferably has an outlet.

This outlet is preferably closeable, for example by means of a plug or a slide valve which can be configured like a slide valve or a plug for a ladle or a tundish in steel production. The melt can by this means be discharged from the outlet of the second furnace vessel without the melting process in the second furnace vessel having to be interrupted.

This has the particular advantage that tilting is not necessary in order to discharge the melt from the second furnace vessel, so that the continuous melting operation in the second casting facility does not have to be interrupted.

The process of the invention for producing a melt for casting using a melting apparatus according to the invention has the following features:
introducing solid casting material into the first furnace vessel;
melting the casting material in the first furnace vessel;
conducting the melt formed in the first furnace vessel into the second furnace vessel;
increasing the temperature of the melt accommodated in the second furnace vessel to the casting temperature for this melt.

The casting material used for the process of the invention and also the melt formed therefrom can be treated as indicated here by the melting apparatus of the invention.

For this purpose, the solid casting material can preferably be present in the form of cast iron or cast steel which is firstly heated to, for example, from 1000° C. to 1300° C. or to from 1400° C. to 1600° C. in the first furnace vessel, then is heated to from 1400° C. to 1600° C. or from 1600° C. to 1700° C. in the second furnace vessel and finally can be conveyed from the second furnace vessel to a downstream treatment or casting unit.

The process of the invention can be part of a more extensive process for producing the castable melt. A central inventive concept of this more extensive process according to the invention is that the melt is, in contrast to the processes known from the prior art, cooled between the initial melting of the casting material from the raw materials and the provision of a castable melt therefrom, so that a solid casting material is formed from the initially formed melt.

According to the prior art, a cast iron or cast steel melt having a desired composition is, as indicated above, firstly produced from the raw materials, in particular pig iron and scrap, and is either cast directly or subsequently fed in the liquid state to a downstream casting furnace from where it is fed to the casting units. According to the prior art, the melt formed from the raw materials therefore always remains in a molten state between melting and casting.

In the process of the invention, however, a melt of a casting material having a desired composition is first formed from the raw materials and is subsequently allowed to cool. This cooled casting material is subsequently melted in the first furnace vessel of the melting apparatus of the invention,

The more extensive process according to the invention accordingly has the following, further process steps preceding the above-described process:
producing a melt of a casting material;
allowing the melt to cool to form a solid casting material;
providing the solid casting material for introducing the solid casting material into the first furnace vessel.

This process has the particular advantage that the melting of the casting material in the melting apparatus of the invention can be decoupled from the melting and production of the casting material having a desired composition.

In this respect, the solid casting materials with which the melting apparatus of the invention is supplied can, for example, be preproduced in any desired amount so that they can be fed when required to the melting apparatus of the invention without delay.

Furthermore, the invention allows the production of a solid casting material having a desired composition to be carried out separately in time and space from the melting of this casting material in the melting apparatus of the invention. The production of the solid casting material with which the melting apparatus of the invention is charged can thus be carried out, for example, in a different production facility than the melting of this casting material in the melting apparatus of the invention.

The melting apparatus of the invention can also be constructed with relatively small dimensions.

Further features of the invention can be derived from the claims, the fl r and the associated description of the figures.

All features of the invention can, individually combination, be combined with one another in any way.

A working example of the invention will be explained in more detail with the aid of the following description of the figure.

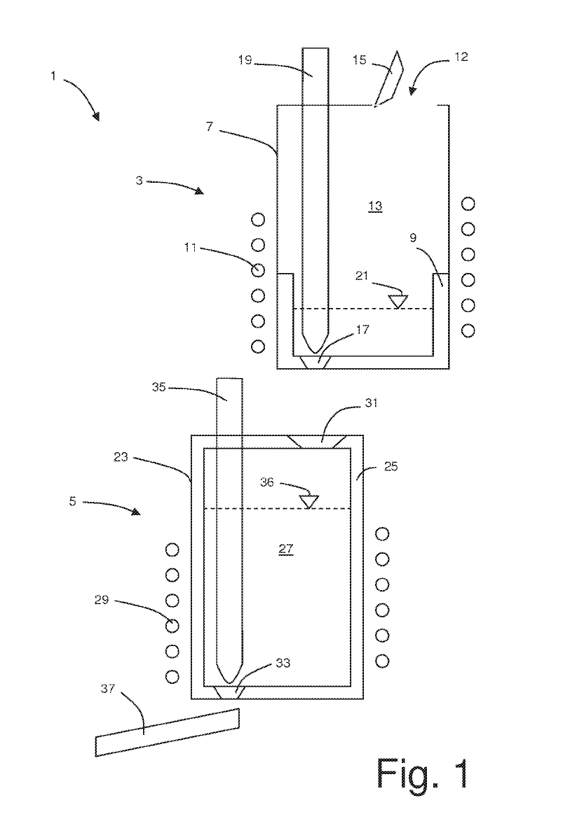

FIG. 1 shows a melting apparatus according to the invention in a sectional side view.

The melting apparatus denoted overall by the reference numeral 1 in FIG. 1 is depicted in a highly schematic embodiment in a sectional side view.

The melting apparatus 1 comprises a first furnace vessel 3 and a second furnace vessel 5,

The first furnace vessel 3 is configured as an induction furnace. The first furnace vessel 3 comprises a sheet metal shell 7 which is lined on the inside at the bottom and in the sections of the side walls adjacent to the bottom with a refractory material 9. The upper region of the side walls of the first furnace vessel 3 is not lined with refractory material 9. The refractory material 9 thus encloses the furnace space 13 on the first furnace vessel 3 only in the bottom region. On the outside, the sheet metal shell 7 is encompassed by an induction coil 11 so that casting material present in the furnace space 13 is inductively heatable. At the top, the first furnace vessel 3 has an inlet 12 through which solid casting material can be introduced into the furnace space 13. The inlet 13 can be closed by a flap 15. At the bottom, the first furnace vessel 3 has an outlet 17 for discharging melt which is composed of the casting material and has been formed in the furnace space 13 of the first furnace vessel 3. The outlet 17 can be closed by a plug 19. The furnace space 13 of the first furnace vessel 3 is configured so that a melt composed of casting material can be accommodated therein up to a bath height 21.

The throughput of the first furnace vessel 3 is about 10 t of cast iron per hour. To be able to melt this amount of solid cast iron per hour, the furnace space 13 or the cast iron present in the furnace space 13 can be supplied with about 4000 kW of power by the induction coil 11.

The second furnace vessel 5 is arranged beneath the first furnace vessel 3. In terms of its basic structure, the second furnace vessel 5 corresponds essentially to the first furnace vessel 3. In this respect, the second furnace vessel 5 has a sheet metal shell 23 which is lined on the inside with its refractory material 25. The refractory material 25 encloses the furnace space 27 of the second furnace vessel 5. To heat the second furnace vessel 5 or a melt present in the furnace space 27 of the second furnace vessel 5, the sheet metal shell 23 of the second furnace vessel 5 is enclosed by an induction coil 29 by means of which the furnace space 27 is inductively heatable. At the top, the second furnace vessel 5 has an inlet 31 through which melt formed in the first furnace vessel 3 can be conducted into the furnace space 27 of the second furnace vessel 5. Here, the inlet 31 of the second furnace vessel 5 is arranged vertically underneath the outlet 17 of the first furnace vessel 3, so that melt flowing out from the first furnace vessel 3 flows under the action of gravity in free fall through the inlet 31 of the second furnace vessel 5 into the furnace space 27 thereof. At the bottom, the second furnace vessel 5 has an outlet 33 which can be closed by means of a plug 35. Melt flowing out of the furnace space 27 on the second furnace vessel 5 through the outlet 33 can be fed to a distributor channel 37 which conducts the melt directly to a casting unit (not shown) located downstream in the process.

The capacity of the second furnace vessel 5 is about 1 t of molten cast iron which comes up to the bath level 36 when the second furnace vessel 5 is completely filled. The furnace space 27 of the second furnace vessel 5 can be supplied with about 1000 kW of power by the induction coil 29.

The process of the invention can be carried out as follows using the melting apparatus 1 shown in the working example:

A solid casting material in the form of solid cast iron is firstly introduced through the inlet 12 into the furnace space 13 of the first furnace vessel 3. In the furnace space 13, the initially solid cast iron is supplied with energy by the induction coil 11 so that the cast iron melts and its melt has a temperature of about 1120° C. The melt formed in this way is discharged through the outlet 17 of the first furnace vessel 3 by opening the outlet 17 by means of the plug 19, so that the melt flows under the action of gravity through the inlet 31 of the second furnace vessel 5 into the furnace space 27 thereof. In the furnace space 27 of the second furnace vessel 5, the melt is supplied with energy by the induction coil 29 so that the melt heats up to a temperature of about 1500° C. The temperature of 1500° C. corresponds to the casting temperature of the melt, so that after this temperature has been reached, the melt flows out of the outlet 33 of the second furnace vessel 5 as a result of opening the outlet 33 by means of the plug 35 and into the distributor channel 37 from where the melt is conducted to the casting molds of the casting unit.

In this process, a solid casting material having a known composition is used. This casting material has been obtained by the more extensive process of the invention, with a melt of the casting material firstly having been produced by raw materials being melted to form a melt of the casting material having a desired composition. The corresponding melt was subsequently allowed to cool, The cold casting material then formed was subsequently made available for introduction of this casting material into the first furnace vessel.

1. A melting apparatus for melting casting materials, comprising:
a first furnace vessel configured for melting casting materials and for accommodating melt formed by melting; and
a second furnace vessel located downstream of the first furnace vessel such that melt formed from casting materials in the first furnace vessel can be conducted into the second furnace vessel;
wherein the second furnace vessel his configured for accommodating the melt which can be conducted from the first furnace vessel into the second furnace vessel and for increasing the temperature of the accommodated melt to the casting temperature for this melt.

2. The melting apparatus as claimed in claim 1, wherein the first furnace vessel inductively heatable.

3. The melting apparatus as claimed in claim 1, wherein the second furnace vessel is inductively heatable.

4. The melting apparatus as claimed in claim 1, wherein the melting apparatus is configured for conducting the melt heated to casting temperature in the second furnace vessel into a treatment or casting device.

5. A process for producing a melt for casting using the melting apparatus of claim 1, wherein the process comprises:
introducing solid casting material into the first furnace vessel;
melting the casting material in the first furnace vessel;
conducting the melt formed in the first furnace vessel into the second furnace vessel; and
increasing the temperature of the melt accommodated in the second furnace vessel to the casting temperature for this melt.

6. The process as claimed in claim 5, wherein the process further comprises:
producing a melt of a casting material;
allowing the melt to cool to form a solid casting material; and
providing the solid casting material for introducing the solid casting material into the first furnace vessel.
